(19) United States
(12) Patent Application Publication
(10) Pub. No.: US 2006/0271223 A1
(43) Pub. Date: Nov. 30, 2006

(54) METHOD AND SYSTEM FOR INTEGRATING EQUIPMENT INTEGRATION SOFTWARE, EQUIPMENT EVENTS, MES AND RULES DATABASES

(75) Inventors: Karl Gartland, Essex Junction, VT (US); Barry M. Herbold II., Beacon, NY (US); Glade S. Keaney, Red Hook, NY (US); Krithikpriya R. Kunka, Poughquag, NY (US); Robert J. MacHugh, Newburgh, NY (US); Parth P. Dave, Wappingers Falls, NY (US); Bradford R. Pousland, Austin, TX (US)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 10/908,835

(22) Filed: May 27, 2005

(51) Int. Cl. G06F 19/00

(52) U.S. Cl. 700/103

(57) ABSTRACT

A manufacturing system configured for automated operational state tracking and management includes an automated manufacturing execution system (MES) in communication with manufacturing equipment, equipment integration software (EIS) configured to provide an interface between the MES and the manufacturing equipment, and a plug-in module in operable communication with the EIS. The plug-in module is configured to automatically obtain information regarding rules for changing defined operational states, and to receive triggering event information from the manufacturing equipment. The plug-in module is further configured to compare the triggering event information with the rules, and to change the present operational state of the manufacturing equipment in accordance with the rules.

### BACKGROUND

The present invention relates generally to automated manufacturing systems, and, more particularly, to a method and system for integrating equipment integration software, equipment events, MES (manufacturing execution systems) and rules databases.

The semiconductor fabrication industry continues to evolve, and has historically followed Moore's law (which predicts a doubling of the number of transistors per integrated circuit every 18 months or so). This exponential growth has translated to approximately 30% cost reduction each year. Typically, the industry has achieved this growth by decreasing the linewidth of the circuits and by increasing the size of the wafers the semiconductors are made on. However, due to increasingly intense competition, this approach is no longer enough to maintain such a pace.

On the other hand, better utilization of the extremely expensive equipment used in semiconductor manufacturing has been achieved by increasing the level of automation in semiconductor factories. For example, tasks such as delivery of work in process, material identification, job start and complete, and recipe download (among others) have been fully automated in 300 mm factories. Process control from this standpoint is on the road to full automation and, in some semiconductor factories (fabs), this goal is nearly complete.

However, there is at least one significant gap with respect to currently existing approaches to full automation of a factory. Specifically, this gap lies in tracking the equipment utilization state of the equipment and the factory. In the early 1990's, the SEMI (Semiconductor Equipment and Materials International) trade association developed SEMI E10, a set of industry-wide standards for buyers, suppliers, and manufacturers of semiconductor manufacturing equipment. SEMI E10 tracks, compares, and evaluates the performance, reliability, availability, and maintainability of semiconductor manufacturing equipment within one factory or among different factories. In particular, SEMI E10 defines how to categorize equipment conditions through its standards, states, and substrates (defined by the user community), which are intended to include all possible conditions and intervals of time for equipment. The SEMI E10 standards are generally considered to be the best method of evaluating the reliability, maintenance, and performance availability of equipment, since they compare equipment failure to equipment use over time instead of simply measuring equipment downtime. Moreover, by using the same E10 standards, fabs are all speaking the same language.

The SEMI E10 states identify general equipment conditions, in which all equipment conditions and periods of time fall into one of the following six states: Productive Time, Standby Time, Engineering Time, Scheduled Downtime, Unscheduled Downtime, and Non-scheduled Time. These defined states are often used in contracts between the equipment owner and the maintenance supplier, with payments from the equipment owner to the supplier being based on reaching a certain percentage of equipment uptime. However, the equipment itself has generally not been configured to recognize the E10 states. More typically, individuals in the factory manually enter the equipment or equipment resource state into appropriate maintenance tracking software.

The SEMI E58 Automated Reliability, Availability, and Maintainability Standard (ARAMS) was a proposed attempt to correct and automate E10 tracking. This standard was created in order to allow the equipment to recognize its own E10 state, and report the same to the factory system. However, E58 requires the factory software and decision report systems to communicate factory level information to the equipment. Not surprisingly, many integrated circuit makers did not permit communication of this type of information to the equipment itself, which would in turn be accessible by the maintenance supplier. As a result, large third-party software supplier-to-equipment manufacturers published a white paper declaring that E58 could not be implemented. This paper, as well as a lack of support for E58 by IC manufacturers, led to the industry rejection of E58.

Still another effort was launched to automate tool productivity tracking, the result being SEMI E116, Equipment Performance Tracking (EPT). E116 allows the equipment to report status information for both the equipment and the individual chambers included therein, whether it is busy, idle, or blocked. Unfortunately, there is not a one-to-one link between the E10 states and the E116 states and, as such, the existing contracts and factory level maintenance tracking software cannot readily use this data. Additionally, many 300 mm legacy tools do not implement the E116 standards.

Due to the high level of automation in 300 mm tools and the need to track chambers and equipment, the legacy method of having an operator enter the E10 state to the factory level system is no longer a satisfactory approach. In order to be more accurate, equipment and chamber states need to be change in close approximation to real time since wafer visits to equipment chambers can be on the order of 30 seconds or less. As some tools can have as many as 7 chambers, an operator is presently needed at each tool to change the E10 state of the chambers, thus negating many of the benefits of the automation.

Accordingly, it would be desirable to be able to implement a system and method to provide automated equipment operational state (e.g., E10) tracking at both the equipment and subcomponent (e.g., chamber) level.

### SUMMARY

The foregoing discussed drawbacks and deficiencies of the prior art are overcome or alleviated by a manufacturing system configured for automated operational state tracking and management. In an exemplary embodiment, the system includes an automated manufacturing execution system (MES) in communication with manufacturing equipment, equipment integration software (EIS) configured to provide an interface between the MES and the manufacturing equipment, and a plug-in module in operable communication with the EIS. The plug-in module is configured to automatically obtain information regarding rules for changing defined operational states, and to receive triggering event information from the manufacturing equipment. The plug-in module is further configured to compare the triggering event information with the rules, and to change the present operational state of the manufacturing equipment in accordance with the rules.

In another embodiment, a method for managing and updating the operational state of equipment in an automated manufacturing environment includes downloading rules for changing defined operational states and receiving triggering event information from the equipment included in the manufacturing environment. Based on the triggering event information and a current operational state of the equipment, a determination is made as to whether the rules provide for a change in operational state, wherein the operational state of the equipment is changed whenever the rules provide for a change in operational state.

### BRIEF DESCRIPTION OF THE DRAWINGS

Referring to the exemplary drawings wherein like elements are numbered alike in the several Figures:

FIG. 1 illustrates the six general equipment conditions identified by the SEMI E10 standard;

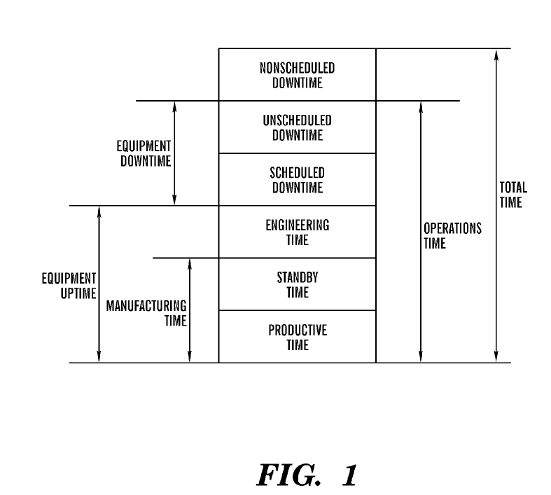

FIG. 2 is a system block diagram of a system for managing automated equipment operational state tracking, in accordance with an embodiment of the invention; and

FIG. 3 is a process flow diagram illustrating a method for automatically updating equipment operational states, in accordance with a further embodiment of the invention.

### DETAILED DESCRIPTION

Disclosed herein is a method and system for providing and managing automated equipment operational state (e.g., E10) tracking at both the equipment and sub component (e.g., chamber) level. In one embodiment, a database is configured to include defined rules for changing the E10 state. The database may be a universal database such as IBM's DB2, for example, although the rules could also be configured within other types of databases. The rules themselves may be created and added to and/or updated within the database by a writer through the use of a Graphical User Interface (e.g., a web based interface).

In addition, the managing system includes a plug in module utility that may be enabled/disabled within existing Equipment Integration Software (EIS) (which also may be known as a cell controller, tool controller, or station controller). To this end, a Linux operating system and Java code may be used for the managing system, although any suitable operating system and coding method would also suffice. In any case, the utility is capable of executing various processes including, but not limited to: requesting the E10 state change rules from the database, accepting a request from the database to accept a new revision of the rules, and reacting to equipment events to change the E10 state of the equipment. The specific number of rules may vary, depending on end user demands. Upon initialization of the EIS, the various workflows (processes) executable by the plug in utility are enabled.

In an exemplary embodiment, the EIS will further attempt to update the rules by querying the rules database for the set of rules pertaining to the applicable tool set. If there is no tool specific set of rules, then the generic rules are retrieved, loaded into EIS memory and saved to a local XML file. The local XML file is used in the event that a connection to the database becomes unavailable, thus allowing the EIS to use a set of rules that was updated on the last successful retrieval. This update by default may advantageously take place during each EIS initialization and, in order to keep the rules as up to date as possible, the rules are updated again and saved locally at the end of the day.

After initialization, the EIS establishes communication with the equipment and “listens” to all events from the tool. Whenever an event that triggers an E10 workflow appears, the EIS initiates the workflow through the plug in utility. In turn, the workflow (using the defined state change rules) will request the MES change the E10 state of the equipment or a chamber, as described in further detail herein.

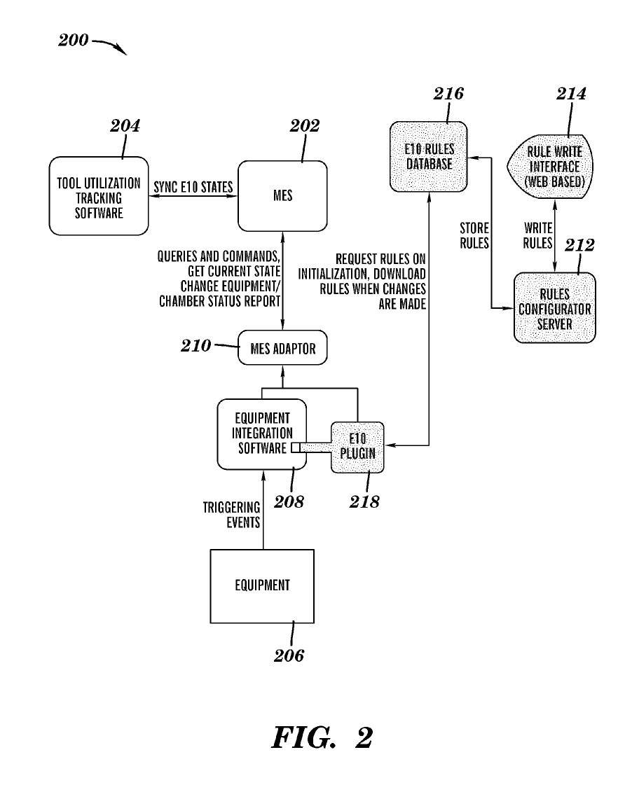

Referring now to FIG. 2, there is shown a schematic block diagram of a system 200 for managing automated equipment operational state tracking, in accordance with an embodiment of the invention. Within a factory software system setting, such as in semiconductor foundry fab for example, a manufacturing execution system (MES) 202 is configured to (among other aspects) keep track of production methods and procedures, work in progress (WIP) information and equipment states, etc. The MES 202 communicates with tool utilization tracking software 204, which keeps track of the factory equipment. In cases where a piece of equipment is undergoing maintenance work, the maintenance status may be manually entered by an operator.

The MES 202 also communicates with the fab equipment 206 through the EIS 208 and, where the EIS operates with a different programming language with respect to the MES, an MES adaptor 210 is also included.

Heretofore, data from the MES 202 was not integrated in a manner that facilitated complete tracking of the E10 states in real time, although an earlier proprietary embodiment of IBM's EIS (not the tool itself) implemented a limited use of the “standby” and “production” states. Even so, conventional equipment cannot implement full E10 state management since the equipment does not understand the type of material it is processing. Thus, the conventional equipment state changes transition from “standby” to “production,” for example. Moreover, the EIS in a conventionally configured fab might request state changes that are actually improper because it does not comprehend the origin of the current E10 state. As such, changes to the E10 states are completely dependent on human decisions.

Accordingly, FIG. 2 further illustrates a rules configurator server 212 configured to define the rules by which the equipment changes from one operational state to another. In the embodiment depicted, a web-based rule write interface 214 is provided to allow a user to access the server 212 and write/update the rules. The graphical user interface (GUI) component of the rule write interface 214 may be written in HTML with JavaScript support, for example, and may be executed in any of the well known web browsers. The back-end of the application may be a standards-based Java application (e.g., uses Servlets, JDBC, Java Beans) written for a J2EE server. The rules configurator 212 server may utilize a custom security model that holds, for example, MD5 encrypted passwords for users and access privilege information for each registered user.

In addition, a centralized relational rules database 216 (e.g., DB2 by IBM) is also configured for storing the rules, the database 216 being accessible by an E10 plug in utility module 218 in communication with the EIS 208. In one embodiment, the EIS is an internally built package called the MSP (Machine Supervisory Program), based on the Linux operating system and Java code. As indicated above, the plug in module 208 incorporates work flows that download the rules from the database 216, react to equipment events communicated to the EIS 208 by the equipment 206, and change the E10 state based on the equipment events and rules.

In operation of the system 200, the EIS 208 is initialized, during which time communications is established with the equipment 206 and a workflow is implemented (through plug in module 210) to request receipt of the latest version of the E10 transition rules as configured within the database 216. The EIS 208 receives communication of all equipment events, some of which initiate workflows that in turn employ data sent by the MES 202. Exemplary triggering events include, but are not limited to: equipment specific events such as chamber clean/start/end conditions and tank charge start/end conditions, front opening unified pod (FOUP) arrival/removal (more generally known as a wafer container, wafer box), and wafer movement or chamber start/end conditions, among others.

The plug-in module 210 to the EIS 208 defines the triggering events and, using the rules downloaded from the rules database and the information from the MES 202, determines the correct E10 state of the equipment (or module) indicated by the triggering event. A request is then sent to the MES 202 change the E10 state of the equipment (or module). Thus configured, the system 200 is advantageous in that it integrates and combines data from several data sources and uses attributes of the material being processed at the equipment to determine the proper E10 state. It should again be noted that in conventional factories, changes to the E10 states are primarily dependent on human input. However, in the present system, changes to the E10 state may still be facilitated by human action in a manner such that the system will consider the “originator” of the state as a factor in deciding if and when to change the E10 state.

Through the configuration of the E10 rules, the present system 200 may (in addition to the EIS simply reacting to equipment events) utilize communication of equipment events along with information from the MES 202 to trigger E10 state change for both equipment and equipment modules. In an exemplary embodiment, the configuration of the specific rules may take into account one or more of the following decision attributes:

1. Type of material processing. Although the types of material defined for a given system 200 are specific to the MES 202 and factory, the rules configurator 212 is defined in a way that allows any defined material types to effect changes to different E10 states. For example, using IBM's SiView MES application, material lot and sublot types are defined that will in turn cause changes to production, engineering, manufacturing support, or various planned down states depending on the lot/sublot type.

2. The current state. In some cases, the arrival of material will not generate an E10 state change or, alternatively, will generate a state change to two or more different states depending on the current state. For example, the arrival of monitors to a tool in the “Unscheduled Downtime” E10 state will not change the E10 state of the tool. However, where monitors arrive at the tool in the “Standby” state, the E10 state would change to “Scheduled Downtime”, “MPSQual” (a specific IBM defined substrate).

3. The originator of the previous state change. (This may also be characterized as the originator of the current state.) For example, if a human operator originated the “Scheduled Downtime” E10 state, the removal of material type monitors would not generate a subsequent E10 state change. On the other hand, if the EIS 208 originated the “Scheduled Downtime” E10 state, the EIS 208 would then change the E10 state to “Standby.”

4. The presence of other material at the equipment. For example, if material of the type “Monitor Build” arrives at a tool and there is no other material present at the tool, the system 200 will change the E10 state of the tool to “manufacturing support.” However, if there were already material of that type present at the tool, then the E10 state of the tool would not change.

5. Equipment specific events. Certain tools may have events occurring therein that dictate the tool's E10 state should change, such as cleans or calibrations, for example. In the present system 200 (in particular, the rules configurator 212 and the rules themselves), any such “tool specific” events are considered with regard to a change in E10 state.

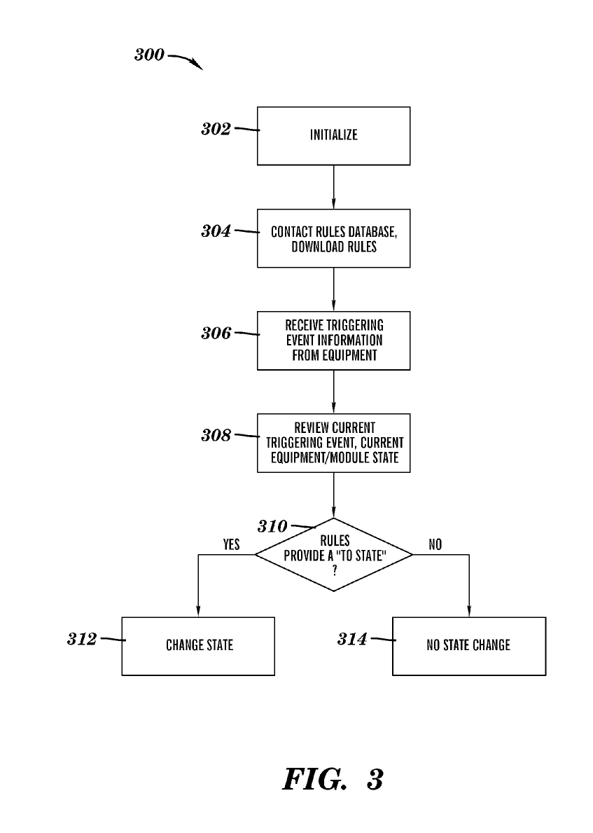

The plug-in module 210 allows workflows to be defined, and may be plugged into any EIS that can employ workflows. As indicated above, there are two general types of workflow items performed by the plug-in module with regard to E10 states, as can further be understood with reference to the process flow diagram 300 of FIG. 3. First, (after system initialization as shown in block 302) the module 210 loads/updates the E10 rules by connecting to the E10 rules database 216 and querying the same for current set of rules specific to the tool (which may be, for example, just a generic set of rules), as shown in block 304. These rules are then loaded into local memory as well as run-time memory. Second, the module 210 updates the E10 states of the tools/chambers/subcomponents by being called throughout the fab operation to change the E10 state.

Specifically, the plug-in module 210 will look at a current triggering event, current chamber/equipment and current module state, as shown in block 306. Then, the module 210 will compare this information to the downloaded E10 rules to see whether a defined “To State” exists, as reflected in decision block 300. If a “To State” exists, then the equipment/module is changed to this “To State” as shown in block 312. On the other hand, if no rule applicable to the current state/event conditions is found, then no E10state change is made, as shown in block 314.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A manufacturing system configured for automated operational state tracking and management, the system comprising:
an automated manufacturing execution system (MES) in communication with manufacturing equipment;
equipment integration software (EIS) configured to provide an interface between said MES and said manufacturing equipment;
a plug-in module in operable communication with said EIS, said plug-in module configured to automatically obtain information regarding rules for changing defined operational states, said plug-in module further configured to receive triggering event information from said manufacturing equipment and compare said triggering event information with said rules and to change the present operational state of said manufacturing equipment in accordance with said rules; and
a rules database in communication with said plug-in module, said database containing said rules for changing said defined operational states, wherein said rules for changing said defined operational states are configured in accordance with decision attributes, said decision attributes including the originator of a previous state change.

2. (canceled)

3. The system of claim 1, further comprising a server in communication with said rules database, said server configured to facilitate generation of and storage of said rules within said rules database.

4. The system of claim 3, further comprising a rule-write interface in communication with said server, said rule-write interface configured to allow a user to generate and update said rules for changing defined operational states.

5. The system of claim 4, wherein said rule-write interface is a web-based interface.

6. The system of claim 1, wherein said rules database comprises a centralized relational database.

7. The system of claim 1, wherein:
said manufacturing equipment further comprises semiconductor manufacturing equipment; and
said triggering event information comprises one or more of: chamber clean start, chamber clean end, tank charge start, tank charge end, wafer container arrival, wafer container removal, wafer movement, chamber start and chamber end.

8. The system of claim 1, wherein said decision attributes further include: type of material processing, present operational state, presence of material at said equipment, and equipment specific events.

9. The system of claim 1, wherein said defined operational states include one or more of: productive time, standby time, engineering time, scheduled downtime, unscheduled downtime, and nonscheduled downtime.

10. A method for managing and updating the operational state of equipment in an automated manufacturing environment, the method comprising:
downloading rules for changing defined operational states;
receiving triggering event information from the equipment included in the manufacturing environment;
determining, based on said triggering event information and a current operational state of the equipment, whether said rules provide for a change in operational state; and
changing the operational state of said equipment whenever said rules provide for a change in operational state;
wherein said rules for changing said defined operational states are configured in accordance with decision attributes, said decision attributes including the originator of a previous state change.

11. The method of claim 10, wherein said decision attributes further include: type of material processing, present operational state, presence of material at the equipment, and equipment specific events.

12. The method of claim 10, wherein said defined operational states include one or more of: productive time, standby time, engineering time, scheduled downtime, unscheduled downtime, and nonscheduled downtime.

13. The method of claim 12, wherein:
the automated manufacturing environment is a semiconductor manufacturing environment; and
said triggering event information comprises one or more of: chamber clean start, chamber clean end, tank charge start, tank charge end, wafer container arrival, wafer container removal, wafer movement, chamber start and chamber end.

14. The method of claim 10, further comprising accepting a request to download an updated version of said rules.

15. An apparatus for implementing automated operational management, comprising:
a server configured to construct rules for changing defined operational states relating to equipment in a manufacturing environment;
said server configured to interface with a graphical user input so as to enable a user to construct said rules; and
said server configured to store said rules within a storage medium in a manner accessible by an application associated with a manufacturing execution system
wherein said rules for changing said defined operational states are configured in accordance with decision attributes said decision attributes including the originator of a previous state change.

16. The apparatus of claim 15, wherein said server interfaces with said graphical user input through a web based interface.

17. The apparatus of claim 15, wherein said storage medium comprises a centralized, relational database.

18. The apparatus of claim 15, wherein said decision attributes further include: type of material processing, present operational state, presence of material at said equipment, and equipment specific events.

19. The apparatus of claim 15, wherein said defined operational states include one or more of productive time, standby time, engineering time, scheduled downtime, unscheduled downtime, and nonscheduled downtime.
